(19) United States
(12) Patent Application Publication
(10) Pub. No.: US 2026/0329626 A1
(43) Pub. Date: Oct. 22, 2026

(54) TASK INTERACTION

(71) Applicant: Beijing Zitiao Network Technology Co., Ltd., Haidian District (CN)

(72) Inventors: Qinghong Chen, Beijing (CN); Yiqi Xiao, Beijing (CN); Jinning Mai, Beijing (CN)

(21) Appl. No.: 19/394,113

(22) Filed: Nov. 19, 2025

(30) Foreign Application Priority Data
Apr. 18, 2025 (CN) 202510497452.3

(51) Int. Cl. G06F 9/48

(52) U.S. Cl. CPC G06F 9/485

(57) ABSTRACT

A method, apparatus, device, storage medium and program product for task interaction are provided. The method includes: presenting, in response to a request for a task of an agent, first execution information for executing a first action of the task in an interface for interacting with the agent, wherein the request comprises task information indicating a requirement of the task; receiving, in response to execution of the first action, an operation on the execution of the first action, the operation indicating an adjustment to or a confirmation of the execution of the first action, wherein the task is suspended; and resuming, in response to receiving the operation on the execution of the first action, the execution of the task by the agent based on the operation.

### CROSS-REFERENCE

The present application claims priority to Chinese Patent Application No. 202510497452.3, filed on Apr. 18, 2025, entitled “Method, Apparatus, Device, Storage Medium and Program Product for Task Interaction”, the disclosure of which is incorporated herein by reference in its entirety.

### FIELD

Example embodiments of the present disclosure generally relate to the field of computers, and in particular, to a method, apparatus, electronic device, computer-readable storage medium, and computer program product for task interaction.

### BACKGROUND

With the development of information technologies, more and more intelligent systems are capable of performing various complex tasks based on user inputs. Such systems usually interact with users in a form of conversations, and generate response contents according to requests in the natural languages of the user, thereby forming question-answering conversations. However, in practical applications, a goal of the user may often not be merely to obtain a reply, but to expect the system to perform complete planning and execution around a certain task. Therefore, how to drive a model based on a task objective to complete execution of a specific task, and improve the structural degree and user controllability of the execution process, becomes an issue worthy of attention.

### SUMMARY

In a first aspect of the present disclosure, a method for task interaction is provided. The method includes: presenting, in response to a request for a task of an agent, first execution information for executing a first action of the task in an interface for interacting with the agent, wherein the request comprises task information indicating a requirement of the task; receiving, in response to execution of the first action, an operation on the execution of the first action, the operation indicating an adjustment to or a confirmation of the execution of the first action, wherein the task is suspended; and resuming, in response to receiving the operation on the execution of the first action, the execution of the task by the agent based on the operation.

In a second aspect of the present disclosure, an apparatus for task interaction is provided. The apparatus includes: an execution information presenting module configured to present, in response to a request for a task of an agent, first execution information for executing a first action of the task in an interface for interacting with the agent, wherein the request comprises task information indicating a requirement of the task; an operation receiving module configured to receive, in response to the execution of the first action, an operation on the execution of the first action, the operation indicating an adjustment to or a confirmation of the execution of the first action, wherein the task is suspended; and an execution module configured to resume, in response to receiving the operation on the execution of the first action, the execution of the task by the agent based on the operation.

In a third aspect of the present disclosure, an electronic device is provided. The electronic device includes at least one processor; and at least one memory, the at least one memory being coupled to the at least one processor and storing instructions executable by the at least one processor. The instructions, when executed by the at least one processing unit, cause the electronic device to perform the method of the first aspect.

In a fourth aspect of the present disclosure, a non-transitory computer-readable storage medium is provided. The non-transitory computer-readable storage medium has computer instructions stored thereon, which, when executed by a processor, implement the method of the first aspect.

In a fifth aspect of the present disclosure, a computer program product is provided. The computer program product includes a computer program, which, when executed by a processor, implements the method of the first aspect.

It would be appreciated that the content described in the Summary section of the present disclosure is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which the embodiments of the present disclosure may be implemented;

FIGS. 2A to 2G illustrate schematic diagrams of interfaces for interacting with an agent according to some embodiments of the present disclosure;

FIG. 3 illustrates a flowchart of a method for task interaction according to some embodiments of the present disclosure;

FIG. 4 illustrates a schematic structural block diagram of an apparatus for task interaction according to some embodiments of the present disclosure; and

FIG. 5 illustrates a block diagram of an electronic device in which one or more embodiments of the present disclosure may be implemented.

### DETAILED DESCRIPTION

The embodiments of the present disclosure will be described in more detail below with reference to the drawings. Although some embodiments of the present disclosure are shown in the drawings, it would be appreciated that the present disclosure may be implemented in various forms, and should not be construed as being limited to the embodiments set forth herein; on the contrary, these embodiments are provided for a more thorough and complete understanding of the present disclosure. It would be appreciated that the drawings and embodiments of the present disclosure are only for illustrative purposes, and are not intended to limit the scope of protection of the present disclosure.

In the description of the embodiments of the present disclosure, the term "include/comprise" and similar terms thereto should be construed as open-ended inclusions, that is, "include/comprise but not limited to". The term "based on" should be construed as "at least partially based on". The term "an embodiment" or "the embodiment" should be construed as "at least one embodiment". The term "some embodiments" should be construed as "at least some embodiments". Other definitions, either explicit or implicit, may also be included below.

As used herein, unless explicitly stated, "in response to A" performing a step does not mean that the step is performed immediately after "A", but one or more intermediate steps may be included.

It would be appreciated that the data involved in the technical solution (including but not limited to the data itself, acquisition, use, storage or deletion of the data) should comply with requirements of corresponding laws, regulations and related provisions.

It would be appreciated that before using the technical solution disclosed in the embodiments of the present disclosure, the relevant users should be informed of the type, range of use, use scenarios, etc. of the information involved in the present disclosure, and the authorization of the relevant users should be obtained, in accordance with the relevant laws and regulations, through an appropriate manner, where the relevant users may include any type of subject of rights, such as individuals, enterprises, and groups.

For example, in response to receiving an active request from a user, prompt information is sent to the relevant user to clearly inform the relevant user that the requested operation will require access to and use of information of the relevant user, so that the relevant user may independently choose, based on the prompt information, whether to provide the information to software or hardware, such as an electronic device, an application, a server, or a storage medium, that performs the operations of the technical solution of the present disclosure.

As an optional but non-restrictive implementation, in response to receiving the active request from the relevant user, the prompt information may be sent to the relevant user in a form of, for example, a pop-up window, in which the prompt information may be presented in text. In addition, the pop-up window may also include a selection control for the user to choose whether to "agree" or "disagree" to provide the information to the electronic device.

It would be appreciated that the above process of notifying and obtaining user authorization is only illustrative, and does not constitute a limitation on the implementations of the present disclosure, and other manners that satisfy the relevant laws and regulations may also be applied in the implementations of the present disclosure.

As used herein, the term "model" may learn a correlation between corresponding inputs and outputs from training data, so that after the learning is completed, a corresponding output may be generated for a given input. The generation of the model may be based on machine learning techniques. Deep learning is a kind of machine learning algorithm that uses multiple layers of processing units to process inputs and provide corresponding outputs. Neural network model is an example of a model based on deep learning. Herein, a "model" may also be referred to as a "machine learning model", a "learning model", a "machine learning network" or a "learning network", which terms are used interchangeably herein.

A "neural network" is a machine learning network based on deep learning. A neural network is capable of processing inputs and providing corresponding outputs, and it typically includes an input layer and an output layer, as well as one or more hidden layers between the input layer and the output layer. Neural networks used in deep learning applications typically include many hidden layers, thereby increasing the depth of the network. The layers of the neural network are connected in sequence, so that an output of a previous layer is provided as an input of a next layer, where the input layer receives an input to the neural network, and an output of the output layer serves as a final output of the neural network. Each layer of the neural network includes one or more nodes (also referred to as processing nodes or neurons), each of which processes input from the previous layer.

Generally speaking, machine learning may roughly include three stages, namely a training stage, a testing stage and an application stage (also referred to as an inference stage). In the training stage, a given model may be trained using a large amount of training data, and a parameter value may be continuously iteratively updated until the model may obtain consistent inference from the training data that meets an expected objective. Through the training, the model may be considered to be able to learn a correlation from input to output (also referred to as a mapping from input to output) from the training data. The parameter value of the trained model is determined. In the testing stage, a test input is applied to the trained model to test whether the model may provide a correct output, thereby determining the performance of the model. In the application stage, the model may be used to process an actual input based on the parameter value obtained from the training, to determine a corresponding output.

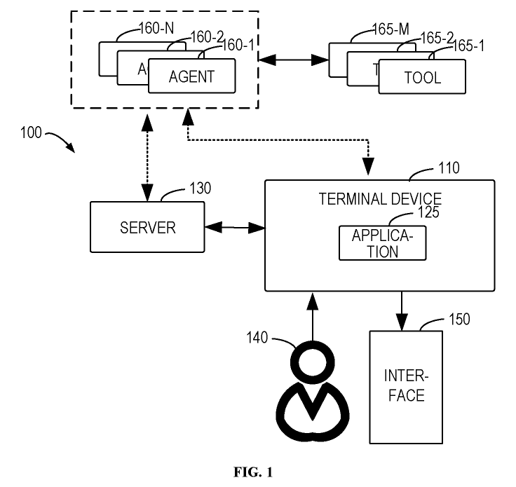

FIG. 1 illustrates a schematic diagram of an example environment 100 in which the embodiments of the present disclosure may be implemented. In the example environment 100, an application 125 is installed on a terminal device 110. A user 140 may interact with the application 125 via the terminal device 110 and/or an attachment device of the terminal device 110.

In some embodiments, the application 125 may be downloaded and installed on the terminal device 110. In some embodiments, the application 125 may also be accessed in other manners, such as via a web page. In the environment 100 of FIG. 1, the terminal device 110 may present an interface 150 of the application 125 in response to the application 125 being launched.

In some embodiments, the terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including accessories and peripherals of these devices, or any combination thereof. In some embodiments, the terminal device 110 may also support any type of user-specific interface (such as a "wearable" circuit, etc.).

In some embodiments, the terminal device 110 communicates with the server 130 to implement service provision for the application 125. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a gaming device, or any combination of the foregoing, including accessories and peripherals of these devices, or any combination thereof. In some embodiments, the terminal device 110 may also support any type of user-specific interface (such as a "wearable" circuit, etc.). The application 125 may be various types of computing systems/servers that may provide computing power, including but not limited to mainframes, edge computing nodes, computing devices in cloud environments, and the like.

In the embodiments of the present disclosure, the application 125 may provide an interaction function with an agent. The application 125 may be an application dedicated to providing agent services, or an application integrated with an agent (that is, may provide other functions or services in addition to the agent). Although a single application is shown in FIG. 1, a plurality of applications may actually be installed on the terminal device 110.

In the present disclosure, agents 160-1, 160-2,..., 160-N (collectively or individually referred to as agent 160) may be deployed locally on the terminal device 110 or deployed remotely. In the case of being deployed remotely, the terminal device 110 may directly invoke the agent, or may invoke the agent via the server 130.

In the embodiments of the present disclosure, the agent 160 may have intelligent dialogue and task processing capabilities. The terminal device 110 provides an interface 150 that may present an interaction with the agent 160. In the interface 150, the user 140 may input a task request for the agent 160 by inputting a natural language (text input or voice input), and may also upload an input online or offline file for dialogue, to instruct the agent 160 to assist in completing various tasks.

In the embodiments of the present disclosure, the agent 160 may process a task indicated by the user in response to a request from the user 140 during an interaction with the user 140. In some embodiments, during the task processing, the agent 160 may invoke one or more tools 165-1, 165-2,..., 165-M (collectively or individually referred to as tool 165) to assist in the execution of the task and the provision of a task result, as required by the task. These tools 165 may be any type of tools, such as a weather query tool, a flight query tool, an information search tool, an online or offline database, an image processing tool, a chart generation tool, a webpage production tool, and the like.

In some embodiments, the environment 100 may further include a management node for the plurality of agents 160-1, 160-2,..., 160-N, which may interact with the plurality of agents 160-1, 160-2,..., 160-N. In some examples, the management node may determine a task requirement corresponding to a task request in response to the task request from the user 140. After that, the management node may assign the task request to an agent 160 matching the task requirement based on the task requirement, to request the agent 160 to execute the task. In some other examples, the management node may further determine an execution plan of the task based on the task requirement. The execution plan of the task may indicate one or more subtasks required to complete the task. The management node may assign the one or more subtasks to one or more agents 160, and the one or more agents 160 may respectively execute their corresponding subtasks. Regarding the management node, in some examples, the management node may be implemented by one of the plurality of agents 160-1, 160-2,..., 160-N (in this case, the agent 160 is also referred to as a management agent 160). In some other examples, the management node may be implemented by a machine learning model, for example, by a language model (LM) or a large language model (LLM).

In some embodiments, the agent 160 may be constructed based on one or more machine learning models. In some embodiments, the machine learning model on which the agent 160 is based may include at least a language model (LM). These machine learning models include content generation models that are capable of generating corresponding outputs based on model inputs. In some embodiments, the machine learning model based on the language model may receive model inputs in a text modality (for example, natural language and/or machine language) and/or model inputs in a non-text modality (for example, images, voice, video, etc.), and may obtain a corresponding model output according to the model inputs and prompts, thereby completing execution of a task. The prompts here are used to guide the machine learning model to generate solutions to user queries indicated by the model inputs. In an application scenario for supporting user conversations, the input from the user 140 may be provided to the machine learning model 160 as at least a part of the model input (other parts may include prompts). The user input is regarded as a question or a query request. Based on the model output, a corresponding response may be provided to the user 140.

It would be appreciated that the structure and functions of the elements in the environment 100 are described for illustrative purposes only, without suggesting any limitation to the scope of the present disclosure.

As briefly mentioned above, with the development of information technologies, intelligent systems driven by natural languages are widely used in scenarios such as content generation, information query, logical reasoning, etc. Conventional intelligent systems mostly construct human-computer interaction processes in a "conversational" manner, where a user inputs a request in a natural language, and the system immediately generates a reply to complete several rounds of conversations. This manner is suitable for conversation interaction tasks, such as question answering, translation, summarization, information query, etc.

However, in actual use cases, a user may often want to obtain not only a piece of information, but also expect the system to complete multi-step operations around a relatively complex objective, such as trip planning, project report generation, research analysis, decision making assistance, etc. Under such requirements, the system not only needs to understand the requirement of the user, but also needs to have comprehensive capabilities such as task organization, external invocation, and result processing. Therefore, how to build a "task-centric" intelligent interaction system and support multi-step execution and user collaborative control has gradually become an important development direction of intelligent systems.

In addition, although some intelligent systems have attempted to expand functions of a language model through mechanisms such as a plugin system or tool invocation, in order to achieve more complex objectives, their interaction manners are still mainly based on "automatic response". Specifically, after the user inputs a task objective in a natural language, an intelligent model is triggered for processing, a series of operations are automatically performed, and a final result is fed back to the user at one time after the execution ends.

This manner has a certain degree of automation capability, but its core feature is still closed-loop execution, that is, from receiving an instruction to outputting a result. The entire process is autonomously completed by the intelligent system, and it is difficult for the user to know the task execution logic in real time, and the user cannot intervene or adjust in intermediate steps. This manner may have the problems of non-transparent interaction and poor controllability when dealing with complex, dynamic or accuracy-demanding tasks. Moreover, during the interaction, the user often checks the output result after waiting for a period of time, but finds that the current result is not satisfactory, and thus needs to initiate a new round of conversation again. Repeating this will seriously affect task efficiency.

In view of this, an improved solution for task interaction is provided according to the embodiments of the present disclosure. According to this solution, first execution information for executing a first action of a task is presented in an interface interacting with an agent in response to a request for the task from the agent, the request including task information indicating a requirement of the task. Then, an operation on the execution of the first action may be received in response to the execution of the first action, the operation indicating an adjustment to or a confirmation of execution of the first action, and the task being suspended. Further, in response to receiving the operation on the execution of the first action, the execution of the task by the agent is resumed based on the operation.

In this way, by introducing a collaborative interaction mechanism during the task execution, the user is enabled to view the execution information in real time in a plurality of actions of the task execution, and confirm or adjust through the user interaction, thereby realizing effective control and flexible intervention on the task execution process. In this way, the problems of non-transparency and uncontrollability caused by a "black-box" task execution process are avoided, making the task execution process more accurate and more in line with user requirements.

In the present disclosure, "trigger" refers to one or more interaction operations of the user on the terminal device. Further, these interaction operations may be triggered within a same user interface/popup window, or may be triggered within different user interfaces/popup windows. The present disclosure is not limited in this regard.

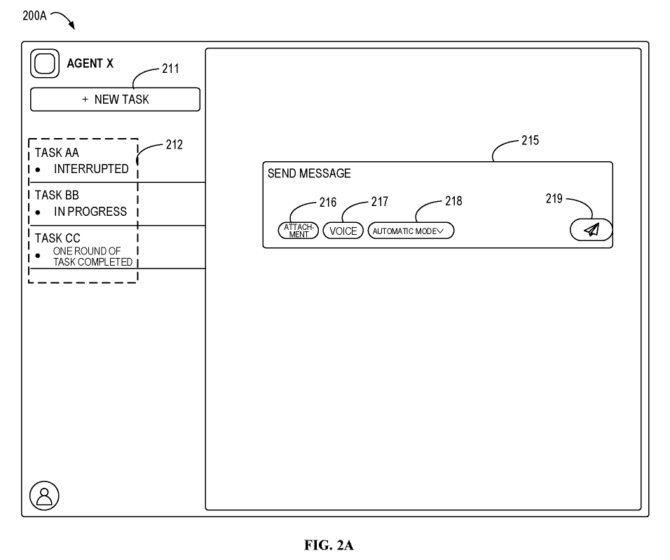

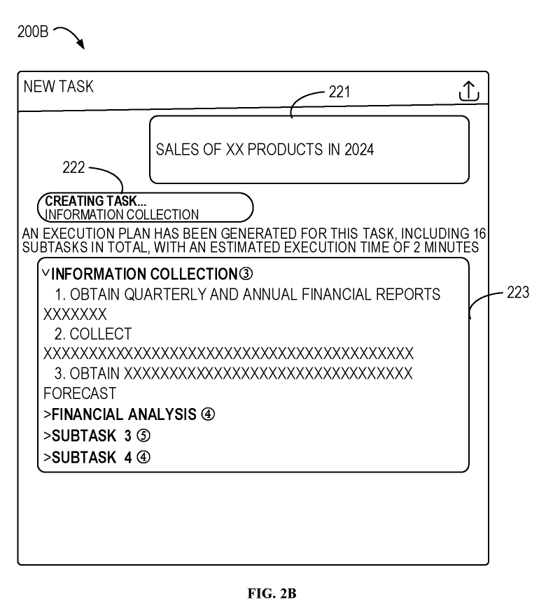

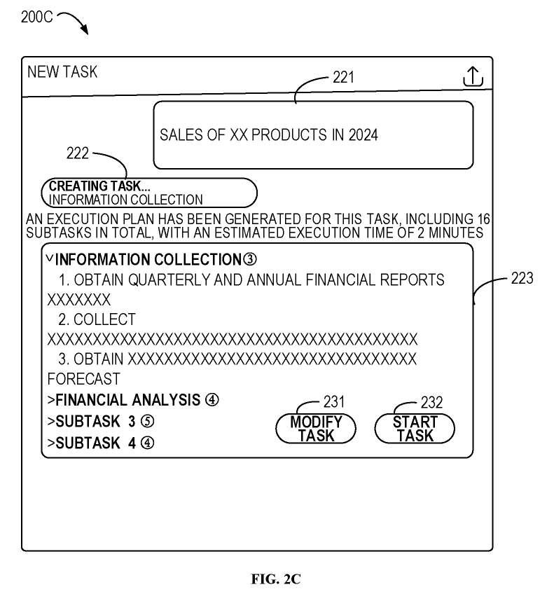

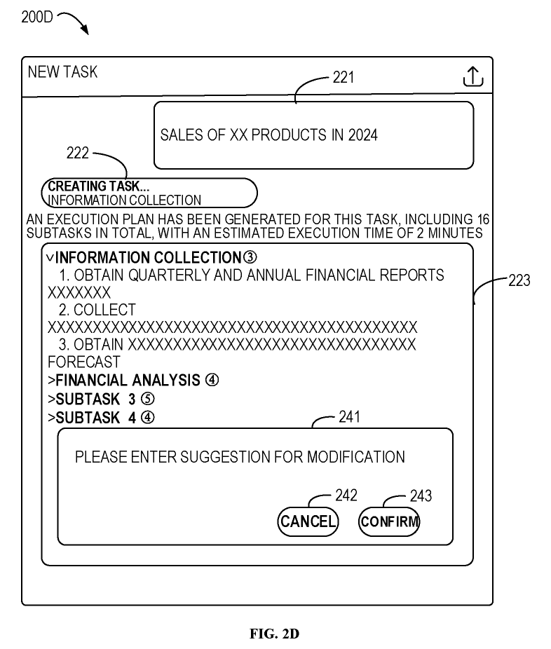

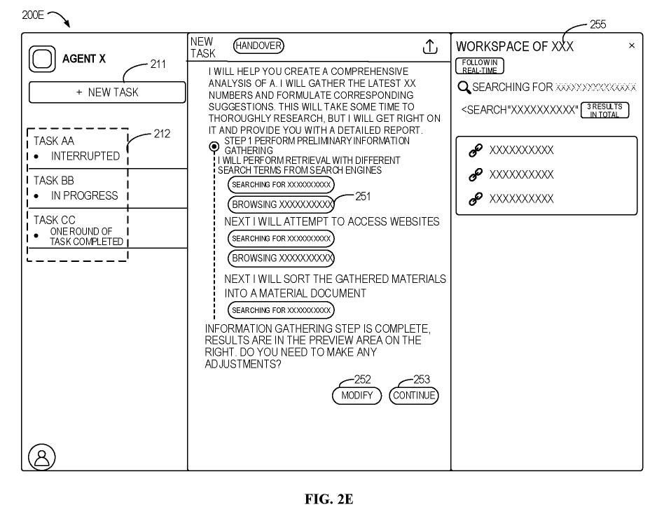

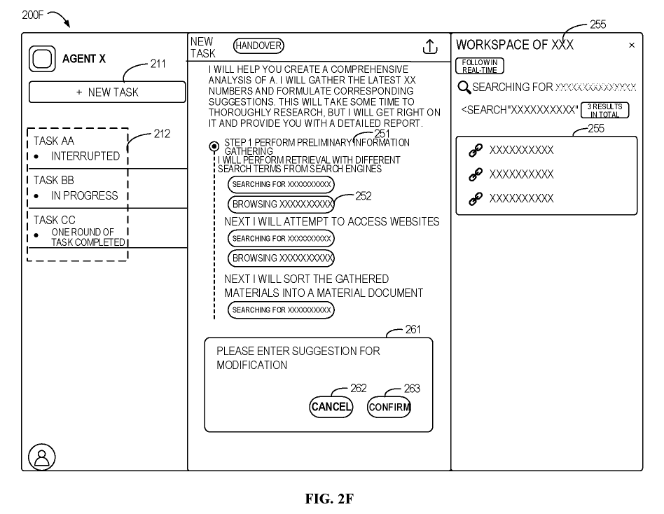

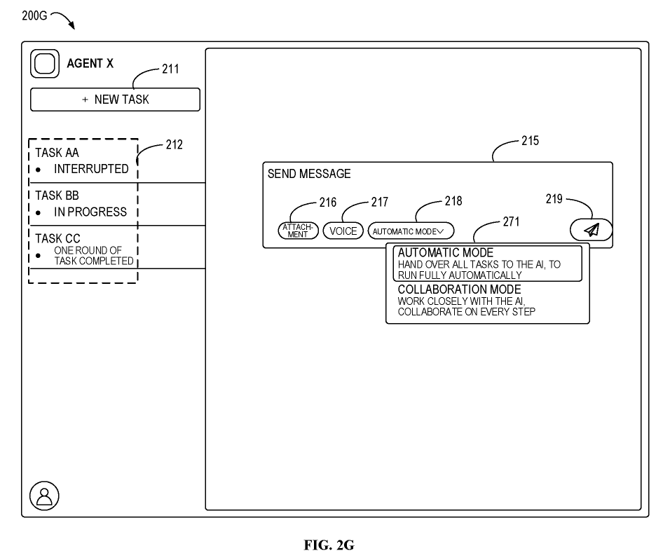

For ease of understanding, examples of interfaces for interacting with an agent in some embodiments of the present disclosure will be described below with reference to FIG. 2A to FIG. 2G. These example interfaces may be presented by the application 125 in the terminal device 110. It would be appreciated that the interfaces shown in the drawings are only examples, and various interface designs may actually exist. The graphic elements in the interface may have different arrangements and different visual representations, one or more of the elements may be omitted or replaced, and there may also be one or more other elements. The embodiments of the present disclosure are not limited in this regard.

An interface 200A shown in FIG. 2A may present an interaction interface 200A between the user 140 and the agent 160. In the interaction interface 200A, a request for a new task initiated by the user may be received. As shown in FIG. 2A, the user may trigger the new task by triggering a "new task" control 211. In response to the triggering of the "new task" control 211, a task-specific interaction interface is presented in the interface 200A, such as an interaction interface 200B shown in FIG. 2B, to initiate the new task in the interaction interface 200B. In some embodiments, an input area 215 for task input is further provided in the interface 200A, in which the user may input a request for a task to be triggered and initiate the request for the task through a "send" control 219. The input area 215 may support text input, for example, inputting text in a text input box, and may also support voice input, for example, by triggering a voice control 217. In addition, the input area 215 may further provide an upload control 216 to support uploading an attachment to indicate the task request of the user. In some embodiments, the interaction interface 200A further provides a task list 212 initiated by the agent 160, the task list 212 indicating various initiated tasks and execution states of the tasks (for example, an interrupted state, an in-progress state, a completed state, etc.).

In some embodiments, a plurality of operation modes of the user 140 and the agent 160 may be provided, and flexible switching between the plurality of operation modes is possible, for example, via a mode switching control 218 shown in FIG. 2A. In a case where a certain mode is triggered, a corresponding interaction area is presented to facilitate the interaction between the user 140 and the agent 160. The manners of interaction between the user 140 and the agent 160 in different operation modes are different, which may flexibly adapt to interaction requirements in different application scenarios.

After the request for the task from the agent is triggered, the terminal device 110 presents the interaction interface 200B shown in FIG. 2B. In the interaction interface 200B, the request for the task initiated by the user, such as a message 221, may be presented, and task execution information when the task is executed by the agent may also be presented. The task execution information may be presented in the interaction interface 200B in a form of one or more messages. During the execution of the task, the agent 160 may analyze the task request initiated by the user to determine a task requirement, thereby generating an execution plan for the task. The execution plan of the task may indicate one or more subtasks required to complete the task. In order to let the user better understand the execution process of the task by the agent, a message 221 indicating the generation of the execution plan may be presented in the interaction interface 200B. After the execution plan is determined, a message 223 indicating each of the subtasks in the execution plan may be presented in the interaction interface 200B. Next, the agent 160 will automatically or in response to the confirmation from the user continue to execute each of the subtasks, and an execution process and an execution result of each of the subtasks may be presented in the interaction interface 200B. After the execution of the entire task is completed, the execution result of the task or an access entry to the execution result (if the execution result needs to jump to other interfaces for presentation) may be presented in the interaction interface 200B. In this way, during the execution process of the entire task, the user may intuitively understand how the agent specifically disassembles the task requirement of the user and the specific execution steps of each subtask, thereby facilitating the user to confirm or adjust the execution process of the task or subtask, to obtain an expected execution result.

In some embodiments, the process of determining one or more subtasks required to complete a task in an execution plan of the task based on a task request from the user 140 may be implemented by a machine learning model deployed at or invoked by the server 130. Further, after determining the specific task execution plan, the machine learning model may assign each subtask to one or more suitable agents 160 for specific task execution.

Alternatively or additionally, the task request from the user may also be sent to the management agent 160. The process of determining one or more subtasks in the execution plan of the task may be implemented by the management agent 160. The management agent 160 may be configured to parse the task request from the user based on the task request from the user 140, thereby determining one or more subtasks required to complete the task in the execution plan of the task. Further, the management agent 160 may assign the subtasks to one or more suitable agents 160 for specific task execution according to different task execution requirements and capabilities.

In some embodiments, the agent 160 may be in a suspended state during the task execution. Options such as modification and resuming may be provided during the suspended state, so that the user may check whether the execution of the current action meets expectations and whether the execution of the action needs to be modified. Then, in a case where the task is modified, the modified task may be passed to the management agent 160. The management agent 160 may assign the modification of the task to other agents. During the task execution, the user 140 may add a new task, for example, add a subtask XX. In such scenarios, the terminal device 110 may invoke the management agent 160 to add the subtask XX. After receiving the subtask XX, the management agent 160 may modify the entire task. Subsequently, the agent 160 may be re-assigned.

In some embodiments, the management agent 160 may determine a prompt corresponding to additional task information indicating a modification to or an addition of the subtask. The prompt may be concatenated into an original system prompt (SP) as a component of the system prompt, so as to provide contextual guidance for subsequent task execution. Alternatively or additionally, the prompt corresponding to the additional task information may be directly concatenated into a task prompt of the agent corresponding to the subtask, so that the corresponding agent may consider new contextual content when executing the task.

Some example embodiments of the present disclosure will be further described below with reference to the drawings. The embodiments involved in the present disclosure may be implemented on the terminal device 110. It should be noted that the operations performed by the terminal device 110 may be specifically performed by a related application (such as the application 120) installed on the terminal device 110. Some operations described with reference to the terminal device 110 may require the assistance of the server 130 to complete.

In some embodiments, the terminal device 110 presents in response to a request for a task of an agent, first execution information for executing a first action of the task in an interface interacting with an agent, the request including task information indicating a requirement of the task. For example, the request includes information related to user requirements, such as indicating a task objective, a constraint, an output expectation, etc. The task information, as a key semantic basis for task driving, guides subsequent task decomposition and execution decision making of the agent.

As an example, referring to FIG. 2A, in the input area 215, the user may input a request for a task to be triggered, and initiate the request for the task through the send control 216, so as to serve as a starting point for triggering a task execution process of the agent 160. The request may include a natural language request for a task objective (such as "help me sort out a research report on XX") input by the user in the input area 215. Alternatively or additionally, the request may further include multimodal forms such as voice and file. For example, the user may provide the task request of the user by triggering the voice control 217 or the upload control 216.

As another example, referring to FIG. 2B, after the request for the task from the agent 160 is triggered, the terminal device 110 presents the interaction interface 200B shown in FIG. 2B. After receiving the request for the task from the agent 160 initiated by the user, the terminal device 110 may perform semantic parsing on the request to recognize a task requirement and constraint information included in the request. Based on a parsed result, the terminal device 110 may determine and execute a first action corresponding to the task, and present first execution information (such as a running state or an intermediate result of the first action) associated with the first action in the interface 200B for the user to view and understand visually. For example, the above-mentioned process in which the agent 160 analyzes the task request initiated by the user to determine the task requirement, thereby generating the execution plan for the task, may be considered as an example process of executing the first action.

In some embodiments, the execution of the task includes a plurality of actions. The task is an overall objective or requirement initiated by the user, such as "help me make a travel plan". An action refers to a phased operation performed to complete the task of the user, which may be an operation unit that is performed by the agent 160 during the task execution and has a clear purpose and an observable execution result. Each action may constitute a stage in a task process and have a phased execution result.

In some embodiments, the plurality of actions included in the execution of the task may include an action indicating the generation of an execution plan for the task, and the execution plan may indicate at least one subtask of the task. For example, the above-mentioned process in which the agent 160 analyzes the task request initiated by the user to generate the execution plan for the task may be considered as one of the plurality of actions.

In some embodiments, the plurality of actions included in the execution of the task may further include at least one subtask indicated by the execution plan. The execution of each subtask may be represented by one action, and the agent 160 may gradually execute these subtasks based on the determined execution plan, thereby gradually completing the execution of the entire task.

In some embodiments, in order to realize human-computer collaboration and dynamic control during the task execution and enhance the controllability of the user on the task execution process of the agent, when the agent 160 completes the execution of the first action or when it is detected that the action process requires user participation during the execution of the first action, an intermediate interaction stage may be entered. In this stage, the terminal device 110 may cache an execution result of the first action and pause automatic advancement of subsequent actions in the task process. Further, if the task process requires user participation, the terminal device 110 may receive an operation for the execution of the first action, which may indicate an adjustment to the execution of the first action or a confirmation of the execution of the first action. The operation may be implemented in various forms. For example, a first interface element and a second interface element are presented in the interface to guide the user to participate in task control.

In some embodiments, the first interface element may indicate an adjustment to the execution of a current action (that is, the first action), such as modifying, replacing or regenerating the execution content. The second interface element may indicate a confirmation of the execution of the first action, that is, represent an approval of the execution result of the agent 160 in an interaction stage of the current action, and may be used as a basis for continuing to advance the task execution process.

In some embodiments, after the user operation is completed, the terminal device 110 may resume an execution process of the task by the agent based on the operation from the user. For example, the terminal device 110 may resume the execution of the task by the agent 160 based on the user's triggering of the first interface element or the second interface element. If the triggering of the first interface element is detected, an adjustment interaction process is entered. In this process, the terminal device 110 may guide the user to supplement, modify or re-plan the current execution action. After the adjustment is completed, the terminal device 110 may re-advance the execution process of the subsequent task. This processing mode ensures that the user may intervene in and reconstruct key task nodes to achieve flexible control and precise guidance. If the triggering of the second interface element is detected, the terminal device 110 may determine that the user has approved the execution result or the intermediate state of the current action. At this time, the terminal device 110 may instruct the agent 160 to continue to execute a next action of the task, that is, the execution task flow only needs to be advanced without interrupting or modifying the current task process.

As an example, FIG. 2C illustrates an example of an interaction interface 200C after a first action is executed, where the first action may indicate the generation of an execution plan for a task. Referring to FIG. 2C, after the user triggers a task request for the agent 160, the terminal device 110 may perform semantic understanding and requirement recognition on a natural language task based on an inference capability of the agent 160. Further, the terminal device 110 may generate a structured execution plan based on user requirements. The process of generating the execution plan may be understood as an execution process of the first action. During the execution process of the first action, the agent 160 may analyze the task request initiated by the user to determine a task requirement, thereby generating the execution plan for the task. The execution plan of the task may indicate one or more subtasks required to complete the task.

Continuing to refer to FIG. 2C, the terminal device 110 may present in the interaction interface 200C a state information area 222 of executing the first action, to prompt a specific action currently executed and an execution state thereof. Each action may include several steps, thereby constituting a basic operation process of the action. For example, the action of "information collection" may include multiple steps such as "invoking a search engine interface", "performing retrieval with different search terms", and "sorting out materials". The execution plan of the task determined by executing the first action and specific steps included in each subtask in the execution plan may be displayed through a message 223.

Continuing to refer to FIG. 2C, the terminal device 110 may further present a first interface element 231 (for example, a "modify task" button) in the interaction interface 200C. When the first action is indicated to disassemble user needs to generate a specific task plan, the execution result of the first action may be a task execution plan including at least one subtask. To support real-time intervention of the user on a task execution solution, the first interface element may be used to trigger an operation of adjusting one or more subtasks generated by executing the first action.

In some embodiments, in response to the triggering of the first interface element 231, the terminal device 110 may present an input control in the interface. The input control may be used to guide the user to input additional task information, such as supplementing constraints, illustrating an expected structure, and adding an omitted subtask. For example, the input control may include a text input box, a task parameter editing area, a task priority setting control, and the like.

Further, in response to receiving the additional task information via the input control, the terminal device 110 may control the agent 160 to re-execute the first action. Then, the terminal device 110 may present updated first execution information of the first action in the interface, where the updated first execution information is generated by the agent 160 through re-execution of the first action based on the additional task information. In other words, the agent 160 may re-analyze and re-disassemble the task based on the cached execution information in combination with the additional task information provided by the user, thereby generating an adjusted task execution plan. The updated task execution plan will be presented in the interaction interface for further confirmation or re-adjustment by the user.

FIG. 2D illustrates an example of an interaction interface 200D after the first interface element is triggered. As shown in FIG. 2D, after the user clicks the "modify task" button based on a requirement for adjusting a subtask, the terminal device 110 may present an input control 241 (for example, an input box) in the interaction interface 200D. The user may input, through the input control 241, supplementary instructions or adjustment suggestions for the current task execution plan, such as "please add one more task A", etc.

Continuing to refer to FIG. 2D, the terminal device 110 may further present a cancel control 242 and a confirmation control 243 in the interaction interface 200D. The cancel control 242 is used to undo a modification process carried by the current input control 241 and return to a presentation interface of the original task plan when the user gives up the modification operation. The confirmation control 243 is used to confirm submission of modification content after the user completes the input.

If the user clicks the confirmation control 243, the terminal device 110 will use the agent 160 to re-execute task decomposition logic based on additional input information from the user, that is, re-execute the first action. The agent 160 generates an updated task plan accordingly. The terminal device 110 will present the updated first execution information in the interaction interface 200D, and display a new subtask list, a new task structure or a new dependency relationship, etc. in a structured form for the user to continue reviewing and confirming.

In some embodiments, when receiving the additional task information provided by the user, the management agent 160 may update or adjust an existing task execution plan based on the additional task information. On the basis of the updated task process, the management agent 160 then decomposes the task into several subtasks and assigns them to appropriate agents for execution, to achieve efficient collaborative processing of the overall task.

Returning to FIG. 2C, the terminal device 110 may further present a second interface element 232 (for example, a "start task" button) in the interaction interface 200C. If the triggering of the second interface element 232 by the user is detected in the interaction interface 200C, the terminal device 110 may instruct the agent 160 to continue to execute a second action of the task. Further, the terminal device 110 may present second execution information of the second action in the interface 200C.

The second action may be one of the at least one subtask determined in the first action (task plan generation). Further, during the execution of the second action, the terminal device may present the second execution information in the user interface, and the second execution information is used to display content or an intermediate result generated by the agent 160 in the execution of a current subtask, thereby realizing a visual presentation and transparent interaction of the task execution process. In this way, the processing process of each subtask may be observed and intervened by the user, thereby enhancing the accuracy, controllability and interaction experience of the task process.

As another example, FIG. 2E illustrates an example of an interaction interface 200E after a first action is executed, where the first action may indicate the execution of a first subtask in a task plan. Referring to FIG. 2E, the agent 160 executes each of the subtasks in the task plan according to a preset task sequence, for example, the subtasks may include operation content such as information collection, content writing, data analysis, etc.

During the execution of the subtask, the agent 160 may perform step-by-step processing on the subtask by combining its inference capability and tool capability. Each subtask may include several steps, thereby constituting a basic operation flow of the subtask. For example, the first subtask may include steps such as accessing a search engine, retrieving a data source related to a keyword, reading web page content, sorting out and caching obtained materials, and so on.

Continuing to refer to FIG. 2E, the terminal device 110 may present in the interaction interface 200E an execution information area 251 for executing the first subtask, to prompt specific execution steps of a current subtask. In this way, the visibility of the user to the task execution process may be improved. Alternatively, or additionally, after the execution of the subtask is completed, the terminal device 110 may display an execution result of the first subtask in a preview area 255 on the right side of the interface in a structured form. In this area, the user may view the execution of the current subtask (for example, files such as a plurality of collected web page links, text summaries, picture materials, etc.), so as to evaluate the execution effect of the subtask.

The terminal device 110 may further present a first interface element 252 (for example, a "modify" button) and a second interface element 253 (for example, a "continue" button) in the interaction interface 200E. The first interface element 252 may be used to guide the user to adjust the execution of the current subtask, such as modifying a subtask objective, resetting a parameter, supplementing an operating condition, and the like. The second interface element is used to confirm the effectiveness of the execution result of the current subtask and instruct the agent 160 to continue to advance the execution of the subsequent subtask.

FIG. 2F illustrates an example of an interaction interface 200F after the first interface element is triggered. As shown in FIG. 2F, after the user clicks the "modify task" button, the terminal device 110 may present an input control 261 (for example, an input box) in the interaction interface 200F. The user may input, through the input control, adjustment suggestions for an execution manner and an execution result of the current subtask, such as "please use a table to display instead", "add data source X", etc.

Continuing to refer to FIG. 2F, the terminal device 110 may further present a cancel control 262 and a confirmation control 263 in the interaction interface 200D. The cancel control 262 is used to undo a modification process carried by the current input control 261 and return to an original presentation interface when the user gives up the modification operation. The confirmation control 263 is used to confirm submission of modification content after the user completes the input.

Further, if the user triggers the confirmation control 263, the agent 160 may re-execute the first action, that is, re-execute the first subtask, based on the cached execution result and the additional task information provided by the user. For example, a re-executed result (that is, the updated first execution information) may include an updated link list, material content that better meets requirements, precisely matched analysis materials, etc.

Returning to FIG. 2E, the terminal device 110 may further present the second interface element 253 (for example, the "continue" button) in the interaction interface 200E. If the triggering of the second interface element 253 by the user is detected in the interaction interface 200E, it indicates that the user has confirmed and approved the execution result of the first subtask and no further adjustment is needed. The agent 160 may continue to execute a second action of the task, that is, a next subtask after the first subtask in the task plan. For example, if the first subtask is information collection, the second subtask may be preliminary content analysis or key information extraction. Further, the terminal device 110 may present second execution information of the second action in the interface 200E.

In the embodiments of the present disclosure, by introducing an intermediate interaction stage during the task execution and setting interface elements for adjusting execution content and confirming execution results, the user may implement real-time intervention and dynamic control on a task process based on execution information presented on an interface after a task execution plan is generated or any subtask is completed.

Returning to FIG. 2A, in order to improve the controllability of the user on the behavior of the agent, the terminal device 110 may receive a selection of an applicable mode for the agent, which may indicate an execution strategy or an interaction strategy adopted by the agent during the task execution. For example, the terminal device 110 may present, in an initial stage after a new task is created, a setting option related to a task execution mode in the interface 200A, such as a setting control 218.

In some embodiments, in response to the triggering of the setting control 218, the terminal device 110 may present a list of applicable modes for the agent, the list of modes including at least a first mode and a second mode. The first mode indicates the execution of the task based on the triggering of the first interface element or the second interface element. In response to receiving the selection of the first mode for the agent, the task is executed by the agent based on the first mode. In a case where the first mode of the agent is selected, the first interface element and the second interface element may be presented in an interface (such as the interaction interface 200C or the interaction interface 200E) of the terminal device 110 in response to the execution of the first action being completed. The second mode indicates that a plurality of actions included in the execution of the task are automatically executed in sequence.

As an example, referring to FIG. 2G, after the user triggers the setting control 218 in the interface, the terminal device 110 may present in the interface 200G a mode list 271 applicable for the agent, which is used to indicate an optional execution mode for a current task execution. The mode list 271 includes at least two modes: a first mode (also referred to as a collaboration mode) and a second mode (also referred to as an automatic mode). The user may select, when creating a task, in what manner the task is to be executed according to actual needs. In the first mode, in a process of the agent 160 executing the task, the execution result of each action requires the operation of the user to advance the execution of the subsequent task. The task advancement process in this mode has a high degree of controllability and interactivity, and is suitable for scenarios in which the user needs to participate in key decisions or has high requirements for execution details. In the second mode, the agent 160 may automatically execute the plurality of actions included in the task in sequence according to an established task process without waiting for the confirmation or intervention from the user. This mode is suitable for scenarios in which the user has full trust in the execution process or expects to complete the task quickly.

In some implementations, the user may not explicitly select any mode at the beginning of task creation. When the user does not select a specific mode, the agent 160 may automatically determine an execution mode of the task based on a default configuration or user requirements. For example, by default, the agent 160 may execute the task based on the automatic mode.

In summary, according to the embodiments of the present disclosure, through the execution mechanism of agent task driving and user interaction intervention, efficient collaboration between the user and the agent is realized in the whole task process, thereby solving the problem of a closed task execution process and low user participation. In this way, the user may dynamically intervene in the process of task plan generation and subtask execution, thereby enhancing the availability of the agent in complex task scenarios and improving the overall user experience.

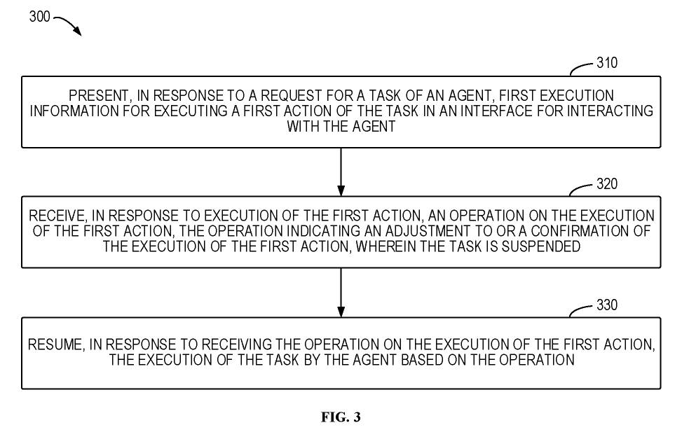

FIG. 3 illustrates a flowchart of a method 300 for task interaction according to some embodiments of the present disclosure. The method 300 may be implemented at the terminal device 110. The method 300 is described below with reference to FIG. 1.

At block 310, the terminal device 110 presents, in response to a request for a task of an agent, first execution information for executing a first action of the task in an interface for interacting with the agent, wherein the request comprises task information indicating a requirement of the task.

At block 320, the terminal device 110 receives, in response to execution of the first action, an operation on the execution of the first action, the operation indicating an adjustment to or a confirmation of the execution of the first action, wherein the task is suspended.

At block 330, the terminal device 110 resumes, in response to receiving the operation on the execution of the first action, the execution of the task by the agent based on the operation.

In some embodiments, the resuming the execution of the task includes: receiving, in response to receiving an operation indicating an adjustment to the execution of the first action, additional task information for adjusting the execution of the first action; re-executing the first action by the agent in response to the receiving the additional task information; and presenting updated first execution information of the first action in the interface, the updated first execution information being generated by the agent through re-execution of the first action based on the additional task information.

In some embodiments, the resuming the execution of the task further includes: continuing to execute a second action of the task by the agent in response to the receiving an operation indicating a confirmation of the execution of the first action; and presenting second execution information of the second action in the interface.

In some embodiments, the method 300 further includes: receiving a selection of an applicable mode for the agent, the mode including at least a first mode and a second mode, the first mode indicating the execution of the task based on the received operation; and executing, in response to the receiving a selection of the first mode for the agent, the task by the agent based on the first mode.

In some embodiments, the method 300 further includes presenting, in accordance with the first mode of the agent being selected, the first interface element and the second interface element in the interface in response to the execution of the first action, the first interface element being configured to receive an operation indicating an adjustment to the execution of the first action, and the second interface element being configured to receive an operation indicating a confirmation of the execution of the first action.

In some embodiments, the second mode indicates that a plurality of actions included in the execution of the task are automatically executed in sequence.

In some embodiments, the execution of the task includes a plurality of actions, and the plurality of actions respectively indicates: generation of an execution plan for the task, the execution plan indicating at least one subtask of the task, and the at least one subtask.

In some embodiments, the first action indicates the generation of the execution plan for the task, and the receiving the operation on the execution of the first action in response to the execution of the first action includes: presenting the execution plan in the interface in response to the generation of the execution plan for the task being completed; and receiving the operation on the execution of the first action, the operation indicating an adjustment to or a confirmation of the execution plan.

In some embodiments, the first action indicates a first subtask of the at least one subtask, and the receiving , in response to the execution of the first action, the operation of a user on the execution of the first action includes: presenting an execution result of the first subtask in the interface in response to the execution of the first subtask being completed; and receiving the operation on the execution of the first action, the operation indicating an adjustment to or a confirmation of the execution result of the first subtask.

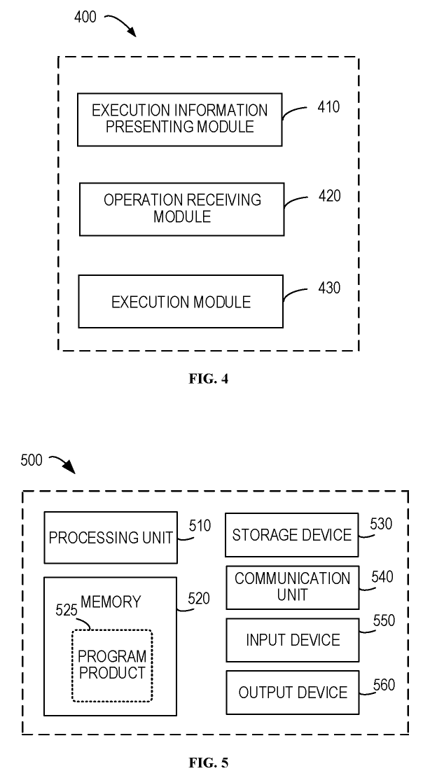

The embodiments of the present disclosure further provide a corresponding apparatus for implementing the above method or process. FIG. 4 illustrates a schematic structural block diagram of an apparatus 400 for task interaction according to some embodiments of the present disclosure. The apparatus 400 may be implemented or included in the terminal device 110, for example. Each module/component in the apparatus 400 may be implemented by hardware, software, firmware, or any combination thereof.

As shown in FIG. 4, the apparatus 400 includes an execution information presenting module 410, an operation receiving module 420, and an execution module 430. The execution information presenting module 410 is configured to present, in response to a request for a task of an agent, first execution information for executing a first action of the task in an interface for interacting with the agent, wherein the request comprises task information indicating a requirement of the task. The operation receiving module 420 is configured to receive, in response to the execution of the first action, an operation on the execution of the first action, the operation indicating an adjustment to or a confirmation of the execution of the first action, wherein the task is suspended. The execution module 430 is configured to resume, in response to receiving the operation on the execution of the first action, the execution of the task by the agent based on the operation.

In some embodiments, the execution module 430 is further configured to: receive, in response to receiving an operation indicating an adjustment to the execution of the first action, additional task information for adjusting the execution of the first action; re-execute the first action by the agent in response to the receiving the additional task information; and present updated first execution information of the first action in the interface, the updated first execution information being generated by the agent through re-execution of the first action based on the additional task information.

In some embodiments, the execution module 430 is further configured to: continue to execute a second action of the task by the agent in response to the receiving an operation indicating a confirmation of the execution of the first action; and present second execution information of the second action in the interface.

In some embodiments, the apparatus 400 further includes a mode selection module, which is configured to: receive a selection of an applicable mode for the agent, the mode including at least a first mode and a second mode, the first mode indicating the execution of the task based on the received operation; and execute, in response to the receiving a selection of the first mode for the agent, the task by the agent based on the first mode.

In some embodiments, the mode selection module is further configured to present, in accordance with the first mode of the agent being selected, the first interface element and the second interface element in the interface in response to the execution of the first action, the first interface element being configured to receive an operation indicating an adjustment to the execution of the first action, and the second interface element being configured to receive an operation indicating a confirmation of the execution of the first action.

In some embodiments, the second mode indicates that a plurality of actions included in the execution of the task are automatically executed in sequence.

In some embodiments, the execution of the task includes a plurality of actions, the plurality of actions respectively indicating: the generation of an execution plan for the task, the execution plan indicating at least one subtask of the task, and the at least one subtask.

In some embodiments, the first action indicates the generation of the execution plan for the task, and the operation receiving module 420 is further configured to: present the execution plan in the interface in response to the generation of the execution plan for the task being completed; and receive the operation on the execution of the first action, the operation indicating an adjustment to or a confirmation of the execution plan.

In some embodiments, the first action indicates a first subtask of the at least one subtask, and the operation receiving module 420 is further configured to: present an execution result of the first subtask in the interface in response to the execution of the first subtask being completed; and receive the operation on the execution of the first action, the operation indicating an adjustment to or a confirmation of the execution result of the first subtask.

The units and/or modules included in the apparatus 400 may be implemented in various ways, including software, hardware, firmware, or any combination thereof. In some embodiments, one or more units and/or modules may be implemented using software and/or firmware, such as machine executable instructions stored on a storage medium. In addition to machine executable instructions or as an alternative, some or all units and/or modules in the apparatus 400 may be implemented at least partially by one or more hardware logic components. As an example, rather than a limitation, example types of hardware logic components that may be used include field programmable gate arrays (FPGAs), application specific integrated circuits (ASICs), application specific standards (ASSPs), system-on-chips (SOCs), complex programmable logic devices (CPLDs), and the like.

It would be appreciated that one or more steps in the above method may be performed by a suitable electronic device or a combination of electronic devices. Such an electronic device or a combination of electronic devices may include, for example, the terminal device 110 in FIG. 1.

FIG. 5 shows a block diagram of an electronic device 500 in which one or more embodiments of the present disclosure may be implemented. It would be appreciated that the electronic device 500 shown in FIG. 5 is only illustrative, and should not constitute any limitation on the functionalities and scope of the embodiments described herein. The electronic device 500 shown in FIG. 5 may include or be implemented as the terminal device 110 of FIG. 1, or the apparatus 400 of FIG. 4.

As shown in FIG. 5, the electronic device 500 is in a form of a general-purpose electronic device. The components of the electronic device 500 may include, but are not limited to, one or more processors or processing units 510, a memory 520, a storage device 530, one or more communication units 540, one or more input devices 550, and one or more output devices 550. The processing unit 510 may be an actual or virtual processor and may perform various processes based on the programs stored in the memory 520. In a multi-processor system, a plurality of processing units executes computer executable instructions in parallel to improve the parallel processing capability of the electronic device 500.

The electronic device 500 typically includes a plurality of computer storage medium. Such medium may be any available medium that is accessible to the electronic device 500, including, but not limited to, volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 520 may include a computer program product 525, which has one or more program modules configured to perform various methods or acts of the various embodiments of the present disclosure.

The communication unit 540 enables communication with other electronic devices via the communication medium. Additionally, the functions of the components of the electronic device 500 may be implemented in a single computing cluster or a plurality of computing machines, which may communicate via communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 550 may be one or more output devices, such as a display, a speaker, a printer, etc. The electronic device 500 may also communicate with one or more external devices (not shown) as needed via the communication unit 540, such as a storage device, a display device, etc., communicate with one or more devices that enable a user to interact with the electronic device 500, or communicate with any devices (e.g., a network card, a modem, etc.) that enable the electronic device 500 to communicate with one or more other electronic devices. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is further provided a computer program product, the computer program product being tangibly stored on a non-transitory computer-readable medium and including computer executable instructions, the computer executable instructions being executed by a processor to implement the method described above.

Various aspects of the present disclosure are described herein with reference to the flowcharts and/or block diagrams of the method, apparatus, device and computer program product implemented according to the present disclosure. It would be appreciated that each block of the flowcharts and/or block diagrams, and combinations of the blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, so that these instructions, when executed by the processing unit of the computer or other programmable data processing apparatus, produce an apparatus for implementing the functions/actions specified in one or more blocks in the flowcharts and/or block diagrams. These computer-readable program instructions may also be stored in a computer-readable storage medium, these instructions causing the computer, the programmable data processing apparatus, and/or other devices to work in a specific manner, so that the computer- readable medium storing the instructions includes a manufactured product, which includes instructions for implementing various aspects of the functions/actions specified in one or more blocks in the flowcharts and/or block diagrams.

The computer-readable program instructions may be loaded onto a computer, other programmable data processing apparatus, or other devices, so that a series of operations and steps are performed on the computer, other programmable data processing apparatus, or other devices to produce a computer-implemented process, so that the instructions executed on the computer, other programmable data processing apparatus, or other devices implement the functions/actions specified in one or more blocks in the flowcharts and/or block diagrams.

The flowcharts and block diagrams in the drawings show the possibly implemented architectures, functionalities, and operations of the system, the method and the computer program product according to a plurality of implementations of the present disclosure. In this regard, each block in the flowchart or block diagram may represent a module, program segment, or part of an instruction, which includes one or more executable instructions for implementing the specified logical functions. In some updated implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform specified functions or actions, or may be implemented by a combination of special-purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope and spirit of the described implementations. The choice of terms used herein is intended to best explain the principles of the implementations, the practical applications or improvements to the technologies in the market, or to enable other ordinary skilled persons in the art to understand the implementations disclosed herein.

1. A method for task interaction, comprising:
presenting, in response to a request for a task of an agent, first execution information for executing a first action of the task in an interface for interacting with the agent, wherein the request comprises task information indicating a requirement of the task;
receiving, in response to execution of the first action, an operation on the execution of the first action, the operation indicating an adjustment to or a confirmation of the execution of the first action, wherein the task is suspended; and
resuming, in response to receiving the operation on the execution of the first action, the execution of the task by the agent based on the operation.

2. The method of claim 1, wherein resuming the execution of the task comprises:
receiving, in response to receiving an operation indicating an adjustment to the execution of the first action, additional task information for adjusting the execution of the first action;
re-executing the first action by the agent in response to receiving the additional task information; and
presenting updated first execution information of the first action in the interface, wherein the updated first execution information is generated by the agent through re-execution of the first action based on the additional task information.

3. The method of claim 1, wherein resuming the execution of the task further comprises:
continuing to execute a second action of the task by the agent in response to receiving an operation indicating a confirmation of the execution of the first action; and
presenting second execution information of the second action in the interface.

4. The method of claim 1, further comprising:
receiving a selection of an applicable mode for the agent, the mode comprising at least a first mode and a second mode, wherein the first mode indicates execution of the task based on the received operation; and
executing, in response to receiving a selection of the first mode for the agent, the task by the agent based on the first mode.

5. The method of claim 4, wherein presenting a first interface element and a second interface element in the interface comprises:
presenting, in accordance with the first mode of the agent being selected, the first interface element and the second interface element in the interface in response to the execution of the first action, the first interface element being configured to receive an operation indicating an adjustment to the execution of the first action, and the second interface element being configured to receive an operation indicating a confirmation of the execution of the first action.

6. The method of claim 4, wherein the second mode indicates that a plurality of actions comprised in the execution of the task are automatically executed in sequence.

7. The method of claim 1, wherein the execution of the task comprises a plurality of actions, the plurality of actions respectively indicating:
generation of an execution plan for the task, the execution plan indicating at least one subtask of the task, and
the at least one subtask.

8. The method of claim 7, wherein the first action indicates the generation of the execution plan for the task, and wherein receiving the operation on the execution of the first action in response to the execution of the first action comprises:
presenting the execution plan in the interface in response to the generation of the execution plan for the task being completed; and
receiving the operation on the execution of the first action, the operation indicating an adjustment to or a confirmation of the execution plan.

9. The method of claim 7, wherein the first action indicates a first subtask of the at least one subtask, and wherein receiving, in response to the execution of the first action, the operation of a user on the execution of the first action comprises:
presenting an execution result of the first subtask in the interface in response to the execution of the first subtask being completed; and
receiving the operation on the execution of the first action, the operation indicating an adjustment to or a confirmation of the execution result of the first subtask.

10. An electronic device, comprising:
at least one processor; and
at least one memory, the at least one memory being coupled to the at least one processor and storing instructions executable by the at least one processor, the instructions, when executed by the at least one processor, causing the electronic device to perform operations comprising:
presenting, in response to a request for a task of an agent, first execution information for executing a first action of the task in an interface for interacting with the agent, wherein the request comprises task information indicating a requirement of the task;
receiving, in response to execution of the first action, an operation on the execution of the first action, the operation indicating an adjustment to or a confirmation of the execution of the first action, wherein the task is suspended; and
resuming, in response to receiving the operation on the execution of the first action, the execution of the task by the agent based on the operation.

11. The electronic device of claim 10, wherein resuming the execution of the task comprises:
receiving, in response to receiving an operation indicating an adjustment to the execution of the first action, additional task information for adjusting the execution of the first action;
re-executing the first action by the agent in response to receiving the additional task information; and
presenting updated first execution information of the first action in the interface, wherein the updated first execution information is generated by the agent through re-execution of the first action based on the additional task information.

12. The electronic device of claim 10, wherein resuming the execution of the task further comprises:
continuing to execute a second action of the task by the agent in response to receiving an operation indicating a confirmation of the execution of the first action; and
presenting second execution information of the second action in the interface.

13. The electronic device of claim 10, wherein the operations further comprise:
receiving a selection of an applicable mode for the agent, the mode comprising at least a first mode and a second mode, wherein the first mode indicates execution of the task based on the received operation; and
executing, in response to receiving a selection of the first mode for the agent, the task by the agent based on the first mode.

14. The electronic device of claim 13, wherein presenting a first interface element and a second interface element in the interface comprises:
presenting, in accordance with the first mode of the agent being selected, the first interface element and the second interface element in the interface in response to the execution of the first action, the first interface element being configured to receive an operation indicating an adjustment to the execution of the first action, and the second interface element being configured to receive an operation indicating a confirmation of the execution of the first action.

15. The electronic device of claim 13, wherein the second mode indicates that a plurality of actions comprised in the execution of the task are automatically executed in sequence.

16. The electronic device of claim 10, wherein the execution of the task comprises a plurality of actions, the plurality of actions respectively indicating:
generation of an execution plan for the task, the execution plan indicating at least one subtask of the task, and
the at least one subtask.

17. The electronic device of claim 16, wherein the first action indicates the generation of the execution plan for the task, and wherein receiving the operation on the execution of the first action in response to the execution of the first action comprises:
presenting the execution plan in the interface in response to the generation of the execution plan for the task being completed; and
receiving the operation on the execution of the first action, the operation indicating an adjustment to or a confirmation of the execution plan.

18. The electronic device of claim 16, wherein the first action indicates a first subtask of the at least one subtask, and wherein receiving, in response to the execution of the first action, the operation of a user on the execution of the first action comprises:
presenting an execution result of the first subtask in the interface in response to the execution of the first subtask being completed; and
receiving the operation on the execution of the first action, the operation indicating an adjustment to or a confirmation of the execution result of the first subtask.

19. A non-transitory computer-readable storage medium having computer executable instructions stored thereon, the computer executable instructions being executable by a processor to implement operations comprising:
presenting, in response to a request for a task of an agent, first execution information for executing a first action of the task in an interface for interacting with the agent, wherein the request comprises task information indicating a requirement of the task;
receiving, in response to execution of the first action, an operation on the execution of the first action, the operation indicating an adjustment to or a confirmation of the execution of the first action, wherein the task is suspended; and
resuming, in response to receiving the operation on the execution of the first action, the execution of the task by the agent based on the operation.

20. The non-transitory computer-readable storage medium of claim 19, wherein resuming the execution of the task comprises:
receiving, in response to receiving an operation indicating an adjustment to the execution of the first action, additional task information for adjusting the execution of the first action;
re-executing the first action by the agent in response to receiving the additional task information; and
presenting updated first execution information of the first action in the interface, wherein the updated first execution information is generated by the agent through re-execution of the first action based on the additional task information.
